(19) United States
(12) Patent Application Publication
(10) Pub. No.: US 2010/0314093 A1
(43) Pub. Date: Dec. 16, 2010

(54) VARIABLE HEAT EXCHANGER

(76) Inventors: Gamal Refai-Ahmed, Markham (CA); Milnes David, Stanford, CA (US); Amy Marconnet, Stanford, CA (US); Josef Miler, Palo Alto, CA (US); Roger Flynn, Tempe, AZ (US); Kenneth E. Goodson, Portola Valley, CA (US)

Correspondence Address: TIMOTHY M HONEYCUTT ATTORNEY AT LAW, P O BOX 1577, CYPRESS, TX, 77410, US

(21) Appl. No.: 12/795,139

(22) Filed: Jun. 7, 2010

Related U.S. Application Data
(60) Provisional application No. 61/186,674, filed on Jun. 12, 2009.

(51) Int. Cl. G05D 23/00; F28D 15/00

(52) U.S. Cl. 165/287; 165/104.31; 165/104.33

(57) ABSTRACT

Various apparatus and methods for thermally managing a heat generating device. In one aspect, a method of thermally managing a heat generating device is provided that includes placing a heat exchanger in thermal communication with the heat generating device. The heat exchanger has an interior space. A membrane is in the interior space between a first chamber and a second chamber. The membrane has a gas impermeable portion and at least one gas permeable portion to enable vapor bubbles in the second chamber to pass through the membrane at the at least one gas permeable portion and into the first chamber. A liquid is moved through the second chamber.

This application claims benefit under 35 U.S.C. 119(e) of prior provisional application Ser. No. 61/186,674, filed Jun. 12, 2009.

### BACKGROUND OF THE INVENTION

1. Field of the Invention

This invention relates generally to semiconductor device systems, and more particularly to methods and apparatus for thermally managing semiconductor chips and related devices.

2. Description of the Related Art

Many types of modern integrated circuits, implemented in semiconductor chips for example, dissipate significant amounts of power in the form of heat. If not managed properly, the generated heat may quickly build up and reduce the performance or even cause the failure of such circuits. The task of removing heat build up from a modern semiconductor chip is complicated by several factors. The first factor is the non-uniform structure of current chips. The structure of a typical semiconductor chip varies greatly from edge to edge and from top to bottom. Some areas have higher circuit density or more metallization than others. This leads to areas of relatively higher heat flux or “hot spots”. The second factor complicating heat management is the tendency for hot spots to move around. Such movements are usually the result of different parts of the chip drawing more power than others at different times depending on the tasks being performed.

A basic conventional form of heat management system for some semiconductor chips is a heat sink, usually with multiple fins, that is placed in contact with the chip. With a relatively large surface area, such sinks rely on conduction, convection and to a lesser extent radiative heat transfer to remove heat from the chip.

A more complicated conventional heat transfer system for some devices includes a micro-channel heat exchanger that is placed in thermal contact with the device. In one conventional design, the micro-channel has a small internal chamber filled with tiny plates that enhance the overall internal surface area. A coolant, typically water, is inside the chamber and circulated by capillary and thermal expansion action or by way of a pumping device. In some designs, the portions of the coolant alternatively vaporize and then condense to liberate heat.

In one particular form of microchannel that utilizes such two-phase flow, a gas permeable membrane is placed inside the micro-channel to divide the interior into a fluid chamber and a vapor chamber. The conventional membrane is fully porous across its entire length (i.e., substantially consistent properties across its length). Vapor formed in the liquid side of the microchannel passes through the membrane and into the vapor chamber where it is vented to atmosphere. The venting of bubbles into the membrane is necessary. Otherwise, bubbles would be held stationary by capillary forces and block liquid from rewetting active surfaces, or consume a large fraction of the flow cross section and add significant flow resistance inside the liquid chamber. Such flow disturbances can cause oscillations or even excursive flow instabilities.

Mechanical strength is one issue associated with the fully porous vapor membrane. Thermal cycling of micro-channel heat exchangers can cause significant mechanical stresses. Thermal conductivity is another issue, since the porous material is not as thermally conductive as, say, a material with a higher density.

An embodiment of the present invention is directed to overcoming or reducing the effects of one or more of the foregoing disadvantages.

### SUMMARY OF EMBODIMENTS OF THE INVENTION

In accordance with one aspect of an embodiment of the present invention, a method of thermally managing a heat generating device is provided that includes placing a heat exchanger in thermal communication with the heat generating device. The heat exchanger has an interior space. A membrane is in the interior space between a first chamber and a second chamber. The membrane has a gas impermeable portion and at least one gas permeable portion to enable vapor bubbles in the second chamber to pass through the membrane at the at least one gas permeable portion and into the first chamber. A liquid is moved through the second chamber.

In accordance with another aspect of an embodiment of the present invention, a method of thermally managing a heat generating device is provided that includes placing a heat exchanger in thermal communication with the heat generating device. The heat exchanger has an interior space. A membrane is in the interior space between a first chamber and a second chamber. The membrane has at least one gas permeable portion. A mechanism is provided to selectively enable and disable fluid communication between the at least one gas permeable portion and the second chamber. A liquid is moved through the second chamber.

In accordance with another aspect of an embodiment of the present invention, an apparatus is provided that includes a heat exchanger that has an interior space. A membrane is in the interior space and between a first chamber and a second chamber. The membrane has a gas impermeable portion and at least one gas permeable portion to enable vapor bubbles in the second chamber to pass through the membrane at the at least one gas permeable portion and into the first chamber.

In accordance with another aspect of an embodiment of the present invention, an apparatus is provided that includes a heat exchanger that has an interior space. A membrane is in the interior space between a first chamber and a second chamber. The membrane has at least one gas permeable portion. A mechanism is provided to selectively enable and disable fluid communication between the at least one gas permeable portion and the second chamber.

### BRIEF DESCRIPTION OF THE DRAWINGS

The foregoing and other advantages of the invention will become apparent upon reading the following detailed description and upon reference to the drawings in which:

FIG. 1 is a pictorial view of an exemplary embodiment of a heat exchanger suitable to provide thermal management for an electronic device, such as a semiconductor chip;

FIG. 2 is a sectional view of FIG. 1 taken at section 2-2;

FIG. 3 is a portion of FIG. 2 depicted at greater magnification;

FIG. 4 is a sectional view of FIG. 2 taken at section 4-4;

FIG. 5 is a sectional view like FIG. 4, but of an alternate exemplary embodiment of a heat exchanger;

FIG. 6 is a sectional view like FIG. 2, but of another alternate exemplary embodiment of a heat exchanger;

FIG. 7 is sectional view of FIG. 6 taken at section 7-7;

FIG. 8 is a portion of FIG. 7 depicted at greater magnification;

FIG. 9 is the portion depicted in FIG. 8 but with a gate therein closed;

FIG. 10 is a view like FIG. 8, but of an alternate exemplary embodiment of a heat exchanger; and

FIG. 11 is a pictorial view of an exemplary heat exchanger inserted into an exemplary electronic device.

### DETAILED DESCRIPTION OF SPECIFIC EMBODIMENTS

Various embodiments of a heat exchanger for use with an electronic device are described herein. One example includes a membrane with gas permeable portions and relatively impermeable portions. Another example includes moveable gates to selectively allow vapor to cross a membrane. Additional details will now be described.

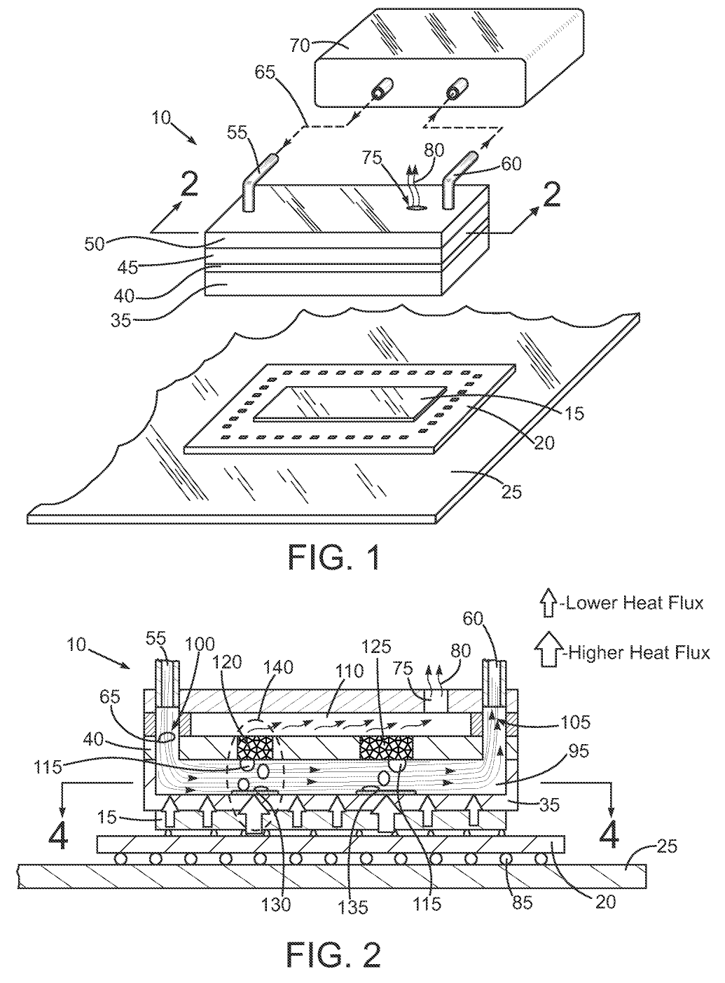

In the drawings described below, reference numerals are generally repeated where identical elements appear in more than one figure. Turning now to the drawings, and in particular to FIG. 1, therein is shown a pictorial view of an exemplary embodiment of a heat exchanger 10 that may be used to provide thermal management for an electronic device, such as a semiconductor chip 15. In this illustrative embodiment, the semiconductor chip 15 is mounted on a carrier substrate 20 that is, in-turn, mounted on a printed circuit board 25. The printed circuit board 25 may be part of some larger system, such as a computer or other computing device. While a single semiconductor chip 15 with a lidless package is depicted, it should be understood that the heat exchanger 10 may be used to thermally manage many different types of electronic devices. The heat exchanger 10 is designed to seat on the semiconductor chip 25 and provide cooling in a variety of ways to be described in more detail below. The heat exchanger 10 is shown exploded from the semiconductor chip 15 for ease of illustration. In practice, however, the heat exchanger 10 is seated on the semiconductor chip 15 directly or perhaps on another heat sink (not shown).

In this illustrative embodiment, the heat exchanger 10 includes a base substrate 35, a vapor transfer membrane 40 positioned on the base substrate 35, an upper substrate 45 positioned on the vapor membrane 40 and a cover 50 positioned on the upper substrate 45. A rectangular footprint is depicted. However, the heat exchanger 10 may have other shapes if desired. Fluid ports 55 and 60 are connected to the heat exchanger 10 for the delivery and removal of coolant 65. The coolant may be water, alcohol, glycol or other liquids suitable for heat transport. The ports 55 and 60 are in fluid communication with a pump 70. The pump 70 may include not only the ability to move fluid, but also the capacity to refrigerate the coolant 65 if desired. In addition, the pump 70 may include or otherwise be provided with a heat sink in order to reduce the temperature of the circulating coolant 65. A vapor vent 75 is provided in the cover 50 in order to liberate coolant vapor 80 that goes into vapor phase during movement through the heat exchanger 10.

Additional details of the heat exchanger 10 may be understood by referring now to FIG. 2, which is a sectional view of FIG. 1 taken at section 2-2. Before turning to the heat exchanger 10 in earnest, a few details of the semiconductor chip 25 will be provided. In particular, the exemplary carrier substrate 20 is depicted as a ball grid array that is direct mounted and interconnected to the printed circuit board 25 by way of plural solder balls 85. The semiconductor chip 15 is depicted as a flip-chip mounted with a plurality of solder joints 90 that interconnect to the carrier substrate 20. The depiction of the semiconductor chip 15, the carrier substrate 20 and the printed circuit board 25 are provided merely for context as the heat exchanger 10 can be used with virtually any type of device that requires active thermal management. With that backdrop, attention is turned again to the heat exchanger 10.

The base substrate 35 may be formed in the shape of a basin. The base substrate 35, the upper substrate 45 and the cover 50 provide an interior space in which the vapor membrane 40 is positioned. The base substrate 35 and the overlying vapor membrane 40 define a flow chamber 95 through which the coolant 65 passes. The coolant 65 is introduced into the port 55 and traverses a bore that is formed in the cover 50, the upper substrate 45 and the vapor membrane 40 leading to the flow chamber. The outlet port 60 is similarly in fluid communication with the corresponding outlet bore 105 that traverses the vapor membrane 40, the upper substrate 45 and the cover 50. The coolant 65 is preferably liquid phase upon introduction into the flow chamber 85, but some vapor phase may be present as well. One function of the base substrate 35 is to provide a low thermal resistance conductive heat transfer pathway from the semiconductor chip 15. Accordingly, the base substrate 35 is advantageously fabricated from thermally conductive materials, such as copper, nickel, silver, aluminum, combinations of these or the like. A thermal interface material (not shown), such as a thermal paste, grease or gel, may be positioned between the base substrate 35 and the semiconductor chip 15 to facilitate conductive heat transfer.

The upper substrate 45 is fashioned with a frame-like design such that an internal vapor chamber 110 is defined between the vapor membrane 40 and the cover 50. In this sense, the vapor membrane 40 is between the flow chamber 95 and the vapor chamber 110. Like the base substrate 35, the upper substrate 45 is advantageously fabricated from thermally conductive materials, such as copper, nickel, silver, aluminum, combinations of these or the like. Well-known adhesives, such as epoxies, may be used to secure the upper substrate 45 to the vapor membrane 40 and the cover 50. Optionally, other fastening methods may be used, such as clamps, screws or the like. The cover 50 may be composed of the same types of materials as the upper substrate 45. The vent 75 in the cover 50 may be a circular bore or other shape. Multiple vents may be used if desired.

As the coolant 65 traverses the chamber 95, bubbles 115 may form depending upon the temperature and flow rate. Unlike a conventional vapor membrane, the vapor membrane 40 is not a gas permeable film. Instead, the vapor membrane 40 includes gas permeable portions, two of which are visible in FIG. 2 and labeled 120 and 125 respectively. The gas permeable portions 120 and 125 allow the vapor bubbles 115 to exit the chamber 95 and enter the vapor chamber 110 as vapor 80 that eventually exits the vent 75. The vapor membrane 40 is composed of two components, a gas permeable material that makes up the gas permeable portions 120 and 125 and is capable of passing the bubbles 115 without significant wicking of the coolant 65, and a relatively gas impermeable material that constitutes the remainder of the membrane 40. In an exemplary embodiment, the gas permeable material may be porous and either surface treated or have native surface properties such that the breakthrough or capillary pressure for the membrane-coolant 65 combination is well in excess of operating pressures in the flow chamber 95. When using water as a working fluid, a hydrophobic surface with contact angles in excess of 90° is advantageous to stop the water from wicking into the gas permeable portions 120 and 125 thus blocking the pores and stopping venting from occurring. The gas permeable material may be a hydrophobic material based on Teflon or a related membrane material. Other options include nanostructured hydrophobic materials based on silicon, silicon dioxide, carbon nanotubes, or related materials.

The relatively gas impermeable remainder of the membrane 40 may be composed of a variety of materials, such as, for example, copper, silicon, aluminum, gold, nickel or the like. In one embodiment, suitable openings may be formed in the membrane 40 to accommodate the gas permeable portions 120 and 125, which may be secured therein by the act of deposition itself, adhesives or other fastening techniques. In another embodiment, the membrane 40 may be fabricated from a gas permeable material of the types just described and thereafter coated with an impermeable material in a pattern that yields the permeable portions 120 and 125.

Since the membrane 40 may be only a few tens of microns thick, mechanical strength is a design issue. However, since many areas of the membrane 40 may be formed from relatively non-porous and thus higher strength materials, the overall mechanical strength of the membrane 40 will be greater than a comparably sized fully porous membrane. The vapor membrane 40 may by secured to the base substrate 35 by way of well-known adhesives, such as epoxies.

It should be understood that the terms “gas impermeable” are not used herein as absolutes. Indeed, even such dense materials as concrete and steel are gas permeable to a small extent. Thus, it should be understood that gas impermeable as used herein is intended to mean much lower gas permeability than the gas permeable portions 120 and 125.

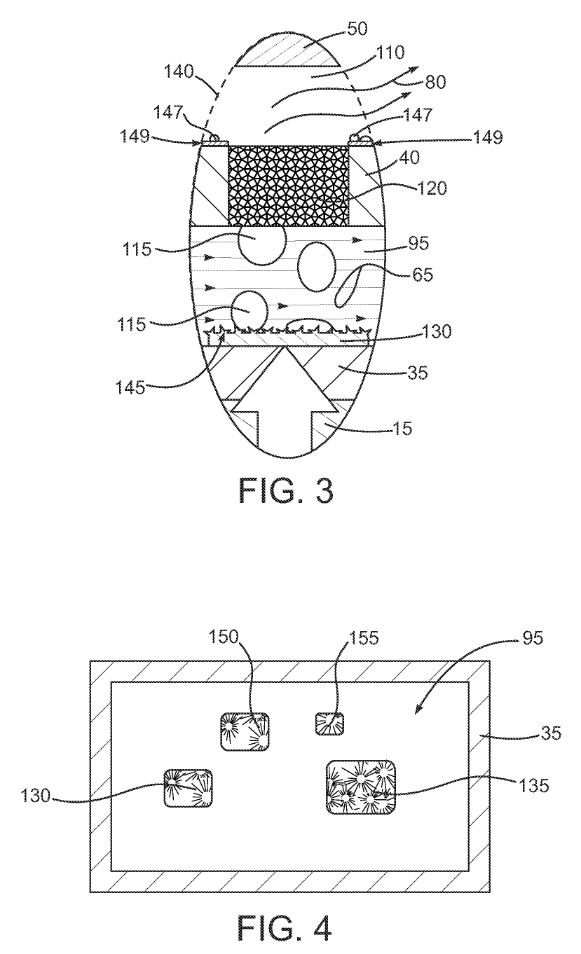

Although two phase flow can often be problematic from a fluid transport standpoint, Applicants have discovered that certain advantages flow from the generation of the vapor bubbles 115 during the movement of the coolant 65 through the chamber 95. In particular, Applicants have ascertained that a higher heat flux from the semiconductor chip or other device being cooled may be obtained wherever the vapor bubbles 115 form. To capitalize on this effect, the heat exchanger 10, and in particular the base substrate 35, may be provided with one or more nucleation sites, two of which are visible and labeled 130 and 135 respectfully. The nucleation sites 130 and 135 are designed to more readily foster the formation of the vapor bubbles 115. The position and size of the nucleation sites 130 and 135 may be tailored to correspond to areas of higher heat flux from the semiconductor chip 15. It is a relatively straight forward matter to thermally map a semiconductor chip to ascertain those positions known as hot spots. In this way, the nucleation sites 130 and 135 may be positioned and dimensioned to correspond to those hot spots of the semiconductor chip 15 that present the highest heat flux. Areas of relatively lower heat flux from the semiconductor chip 15 are still cooled by the heat exchanger 10. The gas permeable portions 120 and 125 may be advantageously positioned proximate respective of the nucleation sites 130 and 135. In this way, for example, bubbles 115 liberated from the nucleation site 130 may quickly move into the gas permeable portion 120 and ultimately the vapor chamber 110. In this way, vapor bubbles 115 may be quickly removed from the fluid chamber 95 so that desirable heat flux is achieved while avoiding flow blockage, diminished fluid flow rate and other issues associated with two-phase flow. The portion of FIG. 2 circumscribed by the dashed oval 140 will be shown at greater magnification and described in conjunction with FIG. 3.

Attention is now turned to FIG. 3. The circumscribed portion 140 includes a portion of the semiconductor chip 25, the base substrate 35, the flow chamber 95, the vapor membrane 40 and the gas permeable portion 120 thereof, the vapor chamber 110 and the cover 50. The nucleation site 130 is clearly visible. In its simplest form, the nucleation site 130 may simply be a portion of the base substrate 35 that is positioned proximate a hot spot of the underlying semiconductor chip 25 at an area of high heat flux. This follows from the simple fact that the areas of the highest heat flux will tend to generate bubbles much more readily than areas of lower heat flux. However, in this illustrative embodiment, the nucleation site 130 includes other enhancements to the bubble formation process. In particular, the nucleation site 130 may include a roughened upper surface 145 that impedes the flow of coolant 65. By impeding the flow path, the velocity of the coolant 65 is reduced locally. Lower velocity translates into more heat transfer to the coolant 65 proximate the nucleation site 130 and thus more ready formation of vapor bubbles 115. Optionally, the nucleation site 130 may be either composed of or coated with a material that promotes vapor formation, such as, for example, small-scale surface roughness achieved, for example, through nanoscale metallic or dielectric particles. Other options include partial surface roughening. Another option is the use of a controlled contact angle at the surface to promote improved nucleation. A myriad of structures may be used to disrupt the flow of the coolant 65 in order to achieve a greater Δtemperature of the coolant 65 proximate the nucleation site 130. Channels, baffles, or other obstructions may be used. As noted above, once the bubbles 115 form, they encounter the gas permeable portion 120, passing there through and entering the vapor chamber 110 as vapor 80.

Some care should be exercised in managing the behavior of the coolant vapor 80 after it enters the vapor chamber 110. It is known that the vapor 80 that is transferred from the flow chamber 95 to the vapor chamber 110 will undergo a change in pressure and a change in temperature, causing some condensation. A few exemplary condensate droplets are shown in either side of the gas permeable portion 120 and labeled 147. The condensed vapor 147, if not evacuated from the vapor chamber 110, could clog the gas permeable portion 120 and inhibit performance. To avoid this scenario, a surface treatment 149 can be applied to the area surrounding the gas permeable portion 120 that will induce motion of the condensed vapor droplets 147 away from the gas permeable portion 120. One type of exemplary surface treatment 149 will create a wettability gradient that drives fluid away from the gas permeable portion 120. In the case of chemical phase separation, surface treatments or additional chemical structures could be applied to this same region to induce, for example, favorable chemical reactions or decontamination of the gas phase before it is evacuated from the vapor chamber. Examples include surface coatings of carbon nanotubes, or nanopillar silicon, either aligned or randomly oriented. Additionally, nanopillars of metals and semiconducting alloys including SiGe, gold, or the like could be used etc. Characteristic pore sizes range from 50 nm to 100 microns. The use of these localized and directional vapor condensate transport and/or treatment schemes would not be possible in prior devices that contain a uniformly porous membrane.

Additional detail of the base substrate 35 may be understood by referring now to FIG. 4, which is a sectional view of FIG. 2 taken at section 4-4. Here, the two nucleation sites 120 and 125 that were visible in FIG. 2, are shown in addition to two other nucleation sites 150 and 155. Like the nucleation sites 120 and 125, the nucleation sites 150 and 155 may be positioned and dimensioned to correspond to the positions and sizes of underlying hot spots on the semiconductor chip (not shown). Indeed, it should be understood that the base substrate 35 may be provided with scores or more of such nucleation sites. In this illustrative embodiment, the flow chamber 95 is a relatively unobstructed open area.

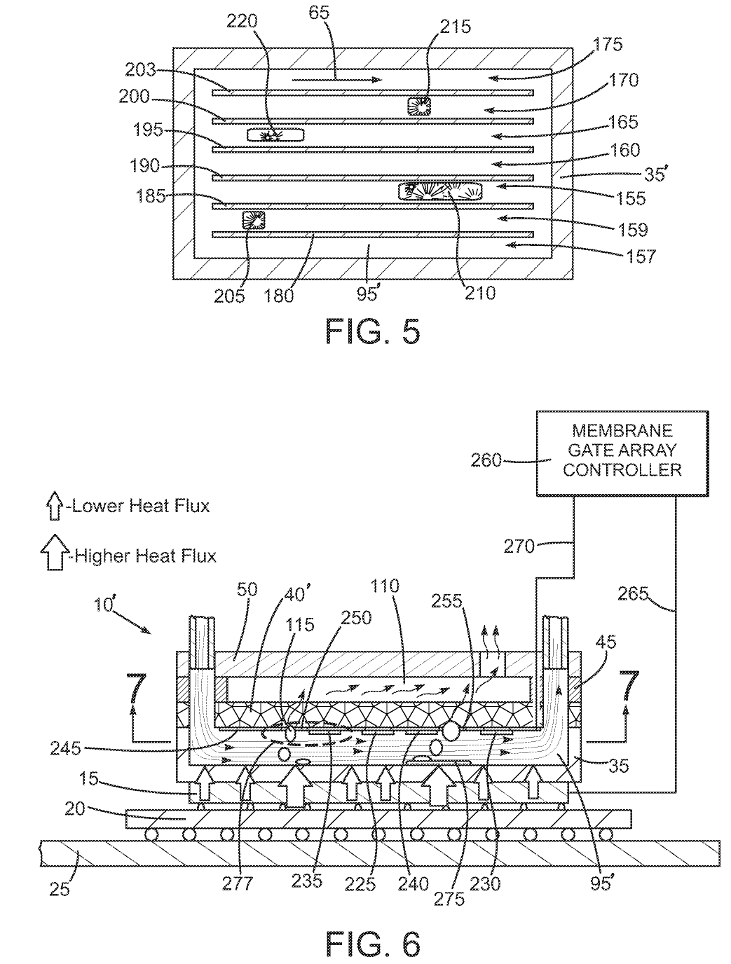

In an alternate exemplary embodiment, the interior of the base substrate may be altered to facilitate greater heat transfer. In this regard, attention is now turned to FIG. 5, which is a sectional view like FIG. 4 but of an alternate exemplary base substrate 35′ that includes a flow chamber 95′ that is provided with a plurality of channels 155, 160, 165, 170 and 175 defined by alternating plates or baffles 180, 185, 190, 195, 200 and 203. The plates 180, 185, 190, 195, 200 and 203 and the channels 155, 160, 165, 170 and 175 not only provide a greater surface area for heat transfer, but also may facilitate the more orderly flow of coolant 65 through the chamber 95′. It should be understood that the plates 180, 185, 190, 195, 200 and 203 and the channels 155, 160, 165, 170 and 175 may be more numerous and quite small, perhaps on the order of a few tens of microns or smaller. Such a device may be termed a microchannel. As with the illustrative embodiment of FIGS. 2, 3 and 4, this alternate embodiment may also utilize nucleation sites, of the type described above, and labeled 205, 210, 215 and 220. As with the other embodiments, the size and number of nucleation sites may be varied greatly.

In the foregoing illustrative embodiment, pathways through the vapor membrane are fixed in advance by pre-selecting the sites for gas permeable versus non-gas permeable portions of the vapor membrane. However, in an alternate exemplary embodiment, the gateways for vapor through the vapor membrane may be dynamically selected based upon the thermal activity of an underlying device and using a mechanism designed to enable selective access. In this regard, attention is now turned to FIG. 6, which is a sectional view like FIG. 2 but of an alternate exemplary embodiment of a heat exchanger 10′. Again, for context purposes only, the heat exchanger 10′ is shown seated on the semiconductor chip 15, that is mounted on a chip carrier 20 and a printed circuit board 25. The heat exchanger 10′ may include a base substrate 35, an upper substrate 45 and a cover 50 as generally described elsewhere herein. However, the vapor membrane 40′ may be fabricated more completely or even entirely of a gas permeable material as shown. However, access to the vapor membrane 40′ by vapor bubbles 115 is dynamically controlled by way of a controllable gate or array of gates. In this regard, two exemplary gates 225 and 230 shown in a closed position and two exemplary open gates 235 and 240 in an open position are shown. The gates 225, 230, 235 and 240 are separated from the vapor membrane 40′ by way of a gate plate 245. With the gates 235 and 240 open, vapor bubbles 115 are allowed to pass through respective openings 250 and 255 in the gate plate 245 and into the membrane 40′. The selective opening and closing of the various gates 225, 230, 235 and 240 is controlled by a membrane gate array controller 260. The membrane gate array gate controller 260 may be implemented as a discrete integrated circuit coupled to the circuit board 25 or to another computing device. Optionally, the functionality of the membrane gate array controller 260 may be performed by various integrated circuits or even be incorporated into the circuitry of the semiconductor chip 15 if desired. The membrane gate array controller 260 is electrically connected to the semiconductor chip 15 and to the various gates 225, 230, 235 and 240 by way of, for example, respective conductors 265 and 270. The conductor 270 is fed through the cover 50, the upper substrate 45, the vapor membrane 40′ and down to the gate array plate 245. The semiconductor chip 15 is provided with on-board temperature sensing devices that are operable to feed temperature information to the membrane gate array controller. When the membrane gate array controller 260 senses a hot spot or area of high heat flux in a particular area of the semiconductor chip 15, the appropriate gates, for example, the gate 235 and 240 may be opened to allow bubbles 115 liberated proximate the hot spot to readily enter the vapor membrane 40′. This provides for a dynamic movement of vapor bubbles 115 wherever they happen to be created with greater frequency due to the thermal situation of the semiconductor chip 15. If desired, an optional nucleation site 275 of the type described elsewhere herein may be provided in the flow chamber 95′. Note the location of the dashed oval 277. The portion of FIG. 6 circumscribed by the dashed oval 277 will be shown at greater magnification in FIG. 8 and discussed further below.

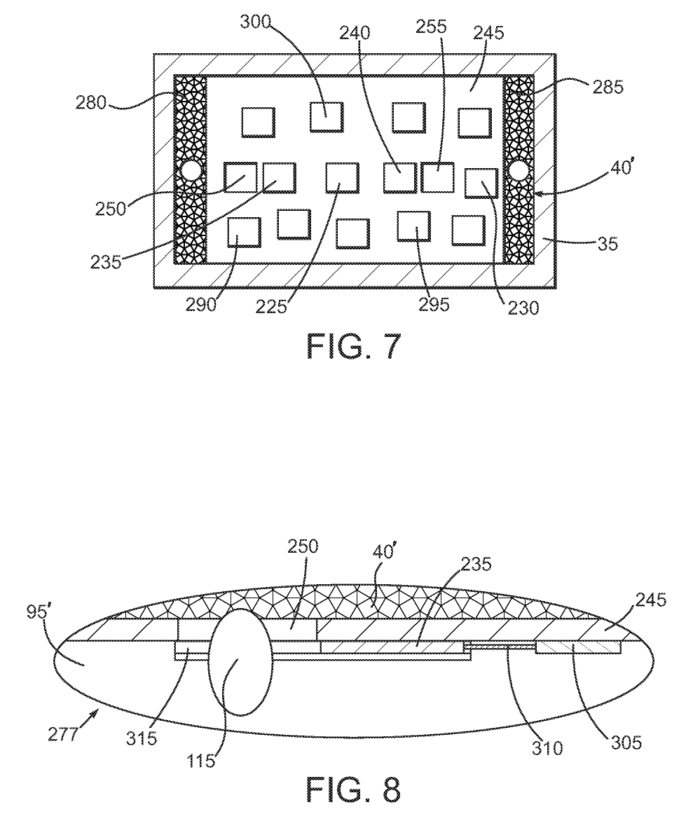

Additional detail of the membrane gate array may be understood by referring now to FIG. 7, which is a sectional view of FIG. 6, taken at section 7-7. The gate array plate 245 need not be coextensive with the entire internal perimeter of the base substrate 35 as shown. In this way, gas permeable portions 280 and 285 of the vapor membrane 40′ may be present. The open gates 235 and 240 and their corresponding ports 250 and 255 are visible. In addition, the two closed gates 225 and 230 shown in section in FIG. 6 are visible as well. In addition, several other gates, such as gates 290, 295 and 300 to name just a few may be provided in other locations in the vapor membrane 40′ to enable vapor to be vented at various locations relative to the semiconductor chip (not shown), but shown in FIG. 6. The number, size, shape and arrangement of the various gates 235, 240, etc. may be tailored to whatever requirements are anticipated.

A variety of actuators may be used to open and close the various gates 235, 240, etc. One illustrative embodiment may be understood by referring now to FIG. 8, which is a magnified view of the portion of FIG. 6 circumscribed by the dashed oval 277. Here, the open gate 235 is shown in section at greater magnification. As noted above, with the gate 235 in the open position shown in FIG. 8, the opening 250 leading to the vapor membrane 40′ is exposed so that a vapor bubble 115 may leave the flow chamber 95′ and enter the membrane 40′. In this illustrative embodiment, the gate 235 may be moved axially by way of an actuator 305 that is connected to the array plate 245 and to the gate 235 by way of a pin or rod 310. The actuator 305, rod 310 and gate 235 may be implemented as well-known microelectromechanical systems or MEMS. For example, the actuator 305 may be implemented as a piezoelectric element capable of bi-directional linear movement. To maintain the proper alignment of the gate 235 during axial movement, a bracket 315 may be connected to the lower side of the gate array plate 245. Because of the location of the sectional view of FIG. 8, the bracket 315 would appear from the side as a pair of spaced-apart L-shaped shelves. It should be understood that positions intermediate full open and closed may be implemented.

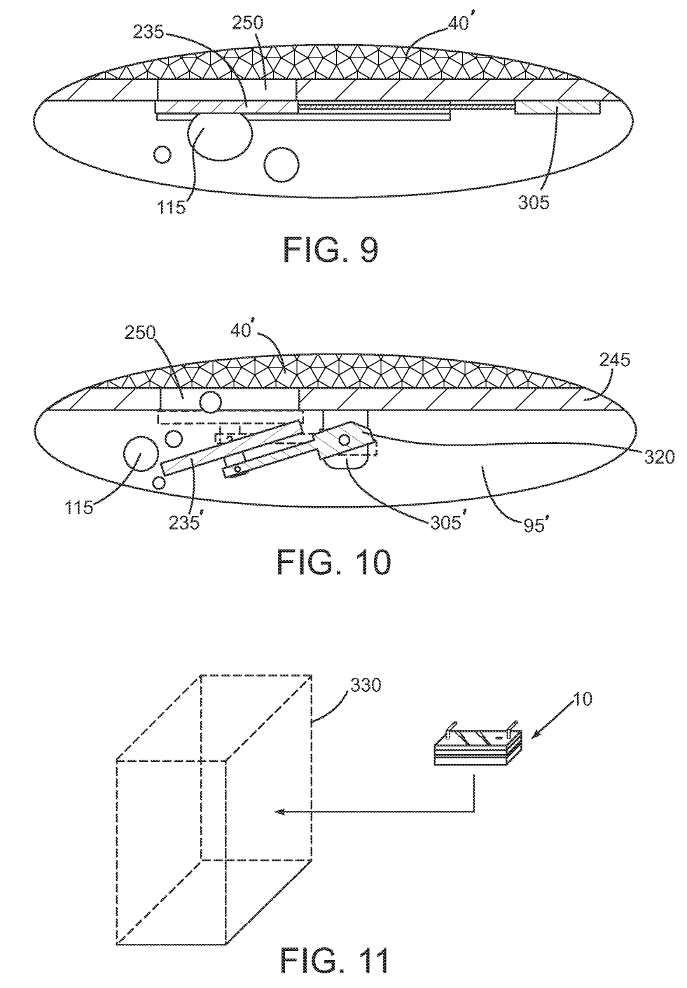

Attention is now turned to FIG. 9, which shows the actuator 310 activated to close the gate 235 over the opening 250 to disable the flow of vapor bubbles 115 into the membrane 40′. Again, the activation of the actuator 305 is controlled by way of the membrane gate controller 260 depicted in FIG. 6.

In an alternate exemplary embodiment, a different type of actuator and gate may be used to selectively open and close openings leading to the vapor membrane. In this regard, attention is now turned to FIG. 10, which is a magnified view like FIG. 9. In this illustrative embodiment, a gate 235′ is pivotally connected to a rotational actuator 305′ by way of a pin 320. The actuator 305′ is connected to the gate array plate 245. In the open position shown, the gate 235′ allows vapor bubbles 115 to enter the opening 250 and thus the vapor membrane 40′. In the closed position shown in dashed, the gate 235′ blocks the opening 250. Like the other illustrative embodiments, the actuator 305′ is controlled by the membrane gate array controller 260 depicted in FIG. 6. The skilled artisan will appreciate that a large variety of different types of mechanisms may be used to selectively open and close passages leading from the flow chamber 95′ to the vapor membrane 40′.

It should be understood that the heat exchanger embodiments 10 or 10′ may be used in a variety of different electronic devices, one of which is shown in schematic form in FIG. 11 and labeled 330. The electronic device 330 may be a computer, a digital television, a handheld mobile device, a server, a memory device, an add-in board such as a graphics card, or any other computing device employing semiconductors.

While embodiments of the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method of thermally managing a heat generating device, comprising:
placing a heat exchanger in thermal communication with the heat generating device, the heat exchanger having an interior space, a membrane in the interior space and between a first chamber and a second chamber, the membrane having a gas impermeable portion and at least one gas permeable portion to enable vapor in the second chamber to pass through the membrane at the at least one gas permeable portion and into the first chamber; and
moving a liquid through the second chamber.

2. The method of claim 1, comprising providing at least one bubble nucleation site in the second chamber.

3. The method of claim 2, wherein the at least one bubble nucleation site comprises a roughened surface.

4. The method of claim 2, wherein the at least one bubble nucleation site comprises a catalyst.

5. The method of claim 2, wherein the at least one bubble nucleation site is positioned proximate the at least one gas permeable portion.

6. The method of claim 1, comprising providing a surface of the membrane facing the first chamber and operable to move condensed vapor away from the at least one gas permeable portion.

7. The method of claim 1, comprising providing the second chamber with a plurality of micro-channels.

8. The method of claim 1, comprising providing a vent in fluid communication with the first chamber to vent vapor.

9. The method of claim 1, wherein the heat generating device comprises a semiconductor chip.

10. The method of claim 1, wherein the liquid is moved by a pump.

11. A method of thermally managing a heat generating device, comprising:
placing a heat exchanger in thermal communication with the heat generating device, the heat exchanger having an interior space, a membrane in the interior space and between a first chamber and a second chamber, the membrane having at least one gas permeable portion, and a mechanism to selectively enable and disable fluid communication between the at least one gas permeable portion and the second chamber; and
moving a liquid through the second chamber.

12. The method of claim 11, wherein the mechanism comprises a movable gate.

13. The method of claim 11, wherein the mechanism comprises an array of movable gates.

14. The method of claim 11, comprising electrically coupling a controller to the mechanism to control the operation of the mechanism.

15. The method of claim 14, wherein the heat generating device has at least one temperature sensor, the method comprising electrically coupling the controller to the at least one temperature sensor so that the controller is responsive to signals from the at least one temperature sensor.

16. The method of claim 11, comprising providing at least one bubble nucleation site in the second chamber.

17. The method of claim 16, wherein the at least one bubble nucleation site comprises a roughened surface.

18. The method of claim 16, wherein the at least one bubble nucleation site comprises a catalyst.

19. The method of claim 16, wherein the at least one bubble nucleation site is positioned proximate the at least one gas permeable portion.

20. The method of claim 11, comprising providing a surface of the membrane facing the first chamber and operable to move condensed vapor away from the at least one gas permeable portion.

21. The method of claim 11, comprising providing the second chamber with a plurality of micro-channels.

22. The method of claim 11, comprising providing a vent in fluid communication with the first chamber to vent vapor.

23. The method of claim 11, wherein the heat generating device comprises a semiconductor chip.

24. The method of claim 11, wherein the liquid is moved by a pump.

25. An apparatus, comprising:
a heat exchanger having an interior space;
a membrane in the interior space and between a first chamber and a second chamber, the membrane having a gas impermeable portion and at least one gas permeable portion to enable vapor in the second chamber to pass through the membrane at the at least one gas permeable portion and into the first chamber.

26. The apparatus of claim 25, comprising at least one bubble nucleation site in the second chamber.

27. The apparatus of claim 26, wherein the at least one bubble nucleation site comprises a roughened surface.

28. The apparatus of claim 26, wherein the at least one bubble nucleation site comprises a catalyst.

29. The apparatus of claim 26, wherein the at least one bubble nucleation site is positioned proximate the at least one gas permeable portion.

30. The apparatus of claim 25, wherein the membrane includes a surface facing the first chamber and being operable to move condensed vapor away from the at least one gas permeable portion.

31. The apparatus of claim 25, wherein the second chamber comprises a plurality of micro-channels.

32. The apparatus of claim 25, wherein the heat exchanger comprises a vent in fluid communication with the first chamber to vent vapor.

33. The apparatus of claim 25, comprising a semiconductor chip in thermal communication with the heat exchanger.

34. An apparatus, comprising:
a heat exchanger having an interior space;
a membrane in the interior space and between a first chamber and a second chamber, the membrane having at least one gas permeable portion; and
a mechanism to selectively enable and disable fluid communication between the at least one gas permeable portion and the second chamber.

35. The apparatus of claim 34, wherein the mechanism comprises a movable gate.

36. The apparatus of claim 34, wherein the mechanism comprises an array of movable gates.

37. The apparatus of claim 34, comprising a controller electrically coupled to the mechanism to control the operation of the mechanism.

38. The apparatus of claim 37, comprising an electronic component in thermal communication with the heat exchanger, the electronic component having at least one temperature sensor electrically coupled to the controller, the controller being responsive to signals from the at least one temperature sensor.

39. The apparatus of claim 34, comprising at least one bubble nucleation site in the second chamber.

40. The apparatus of claim 39, wherein the at least one bubble nucleation site comprises a roughened surface.

41. The apparatus of claim 39, wherein the at least one bubble nucleation site comprises a catalyst.

42. The apparatus of claim 39, wherein the at least one bubble nucleation site is positioned proximate the at least one gas permeable portion.

43. The apparatus of claim 34, wherein the membrane includes a surface facing the first chamber and being operable to move condensed vapor away from the at least one gas permeable portion.
